(19) United States
(12) Patent Application Publication
(10) Pub. No.: US 2007/0174180 A1
(43) Pub. Date: Jul. 26, 2007

(54) Reverse auction system with retractible bids

(76) Inventor: David Shin, Singapore (SG)

Correspondence Address: BERLINER & ASSOCIATES;Robert Berliner, 31st Floor, 555 W. Fifth Street, Los Angeles, CA, 90013, US

(21) Appl. No.: 11/655,323

(22) Filed: Jan. 18, 2007

Related U.S. Application Data
(60) Provisional application No. 60/762,341, filed on Jan. 25, 2006.

(51) Int. Cl. G06Q 40/00

(52) U.S. Cl. 705/37

(57) ABSTRACT

An improvement in a reverse auction in which bids for one or more articles of merchandise or one or more services are made by bidders, the winner of the auction being the bidder with the lowest unique bid at the end of the auction. Each bidder is allowed a predetermined number of bids and may retract one or more of his or her bids and replace them with other bids. During the course of the auction, each bidder is provided with information about the bidding for the auction comprising one or more of: (1) the total number of bids, (2) the total number of bidders, (3) the total number of higher bids, (4) the total number of lower bids, (5) the total number of higher unique bids, (6) the total number of lower unique bids, or (7) the total number of bids same as this bid.

### CROSS-REFERENCE TO RELATED APPLICATIONS

This application claims the benefit of Provisional Patent Application No. 60/762,341, filed Jan. 25, 2006.

### FIELD OF THE INVENTION

The invention relates to reverse auction systems.

### BACKGROUND OF THE INVENTION

Reverse auction systems exist where bidders are able to place bids for specific items or services over mobile or Internet networks. Each bidder is charged a fixed amount for placing the bid, for example $2.00 for each bid placed. After a set period of time that can vary with the nature of the prize, the auction is stopped and a winner, if any is declared. The winner of the auction is the person placing the lowest unique bid at the end of the allotted bid time. The lowest unique bidder is the person who has bid the lowest amount that no other person has bid. When two people place the same bid, that number is no longer unique. When a person has a unique bid but there are others that are lower, then it's not the lowest. To win such an auction, you must be the one with the lowest and unique bid at the auction's end. The winner of the auction must pay the bid amount in order to claim the prize. The following table illustrates the process in greatly simplified form:

### Lowest Unique Bid for a Prize

| | Cost of Bids | Bids |
|---|---|---|
| Participant A | $2 | $0.10 |
| Participant B | $2 | $0.05 |
| Participant C | $2 | $0.05 |
| Participant D | $2 | $0.25 |

In the foregoing auction, Participant A is the winner with the lowest unique bid of $0.10. The bids of $0.05 of participants C and D are lower than participant B's bid, but are not unique. Participant D's bid of $0.25 is unique but is not the lowest unique bid. The organizer of the reverse auction collects a total of &8.00 as the bid fees.

In nearly all jurisdictions, such a reverse auction service would be deemed to be either gambling or a form of lottery that requires the company providing the auction service to hold a gaming license or the like. However, a US based company recently launched a free model as a mobile site using text messages, but once play has started, it can be continued on an internet web site. Revenues are generated via sharing of text fee revenue with the carriers and through paid advertising. Requiring that bids be paid for, either directly by a charge per bid, or indirectly by paying the phone company (who then rebates to the game owner) limits the number of bidders for an auction item. Some systems require verifiable registration to eliminate people posing as different bidders. However, because the repeated use of the auction process is required to exercise any type of strategy, it soon becomes apparent that it is expensive to play the reverse auction game, thereby limiting eventual participants, which in turn limits the quality of the prizes until a balance is struck between number of participants and prize quality. In any event, such reverse auction systems eventually have limited appeal.

Moreover, the ability to use strategy is limited and they rely on luck for the most part. To facilitate some strategy, some systems provide tips along the way. For example, the bidder can be notified of the status of the bid in relation to all other bids that have been received, with follow up notifications at the discretion of the organizer. Since regular carrier charges may apply in connection with such notifications, carrier charges can mount.

Accordingly, what is needed is a system and method for a reverse auction that enables play by a large number of bidders, preferably without cost, or only limited cost, to the bidders (other than paying the winning bid), yet limit the number of bids, and is otherwise structured so as to allow for a greater amount of strategy in play.

### BRIEF SUMMARY OF THE INVENTION

The present invention overcomes the foregoing drawbacks by allowing participants to play without individually paying for bids. The participants are given a predetermined number of bids and in one embodiment they are given information about the bids and limited information about their position with respect to unique bids. In another, and quite significant, embodiment, the participant is allowed to retract any bid or bids, so that one or more bids can be replayed, using the bid information to enhance the ability to employ strategy in play.

While the present invention has embodiments that are implemented as a mobile system for cell phones, it is to be implemented as well on the internet so that it is truly free to the participants. Global Internet advertising expenditure has increased from US$9.6 billion in 2001 to US$27 billion in 2006 with an estimated spend of US$61 billion in 2010. The US internet advertising market is estimated at $12 billion and projected to grow 25%-30% per year for the next 5 years. Consumers are spending more time on the internet and less on traditional media so that advertising has taken over from e-commerce as the biggest source of internet revenues. Web businesses that provide a community experience and uniquely fill a void can rapidly grow a large participant base and are receiving very high enterprise valuations.

Participants will have access to a personal menu that will display all of their bids and the status of the bids. Once a bid is submitted, a fixed period of time elapses before being displayed on the menu. Furthermore, participants of the service may retract their bids at any time prior the end of the predetermined period of time for the auction. This would enable the participants to use that retracted bid to make another bid. This system would also allow another bidder to potentially have an unsuccessful bid become a successful bid.

More particularly, reverse auction is implemented on a computer and can be conducted on an internet web site and/or on a mobile system accessible by cell phones. Each bidder is allowed a predetermined number of bids can be used in single auction or divided between two or more auctions. During the course of the auction, each bidder is provided with information about the bidding, which can include: (1) the total number of bids, (2) the total number of bidders, (3) the total number of higher bids, (4) the total number of lower bids, (5) the total number of higher unique bids, (6) the total number of lower unique bids, and/or (7) the total number of bids same as this bid. Each bidder may retract one or more of his or her bids at any time before the end of the auction and make one or more bids in place of the one or more retracted bids. In a preferred embodiment, no charge is made to the bidders for participating in the reverse auction. The reverse auction can be terminated at the end of a predetermined period of time or when a predetermined number of bids have been placed.

In particular embodiments, bids are distributed to bidders in accordance with the bidders' membership in specific organizations and/or items of merchandise or services to be auctioned are made available to bidders in accordance with the bidders' membership in specific organizations.

### BRIEF DESCRIPTION OF THE DRAWINGS

For a more complete understanding of the present invention, reference is now made to the following descriptions taken in conjunction with the accompanying drawing, in which:

FIG. 1 is a sample home page of an internet web site illustrating aspects of the invention;

FIG. 2 is sample status page of the invention;

FIG. 3 is sample bid status page of the invention that is updated dynamically and interactively, both visually, with a moving line meter, and numerically;

FIG. 4 depicts sample pages of a mobile, cell phone, site, illustrating aspects of the invention;

FIG. 5 is a sample bid mobile status page of the invention that is updated dynamically and interactively;

FIG. 6 is a block diagram of a free reverse auction system according to one embodiment of the invention;

FIG. 7 is a block diagram of an end participant device in the free reverse auction system of FIG. 6 according to one embodiment of the invention; and

FIG. 8 is a process flow diagram of a process engaged by a free reverse auction server for receiving and updating bid status information according to one embodiment of the invention.

### DETAILED DESCRIPTION OF THE INVENTION

The present invention is a completely unique and never seen business. It not only provides “free” reverse auctions, but also provides a unique method of dynamically updating the information given to participants about the status of their bids, and uniquely allows the participants to retract bids, thereby enhancing their ability to employ strategy and not just luck. Participants can receive bid updates almost instantaneously and have the option of retracting one or all of their 5 pre-determined number of bids and re-bidding on the same item or other items.

The ability to provide a “free” bidding process (or if the participant can subscribe to a monthly service of value that provides free bids) enables the service to provide bid retraction. Bid retraction and bid status enables participants to interactively bid on the commodity or service, knowing at any given time, whether their bid is unique and lowest among existing active bids. The status of the bids can include any or all of the following information:

i. Total number of bids,

ii. Total number of bidders,

iii. Total number of higher bids,

iv. Total number of lower bids,

v. Total number of higher unique bids,

vi. Total number of lower unique bids,

vii. Total number of bids same as this bid.

Providing the bid status enables participants to calculate odds and make a more educated bid by retracting their bid and submitting a new bid or by just submitting a new bid and keeping the old bid. Furthermore, the participant would be able to make multiple bids and narrow the options for successful bids. This process being interactive also allows unsuccessful bids to become successful if all other bids at a certain price are retracted prior to the end of the auction. The ability to sort by the number of bids on any given commodity or service also allows participants to bid on items that are not as popular thus increasing their chances of winning the bid. Given information about the time left on a particular bidding event and determining the number of bids submitted further enhances the participant's ability to determine their odds of winning any given bid process.

A business model system is provided wherein participants have access to a free reverse auction, or to a monthly or yearly paid subscription reverse auction system. The reverse auction is conducted for new or used goods and/or services over mobile and internet networks. Winners of the reverse auction are participants of the mobile and internet networks who submit the lowest unique bid at the end of a predetermined period of time. Participants are eligible to use the system by either 1) enrolling in a monthly or yearly paid membership to have access to the bidding system. 2) enrolling in a monthly or yearly paid membership for other goods and services to be provided that is independent to the reverse auction service, 3) enrolling in a system where participants would be exposed to advertisements, or 4) enrolling to a mobile or internet service providers to have access to the bidding system. Participants can be allowed either, a pre-determined number of bids or an unlimited number of bids.

Every unique participant will begin with, say, 5 bids at any given time. Limiting the number of bids not only makes the auction fair, but also makes the bids a valuable commodity that can be used to encourage participants to recruit other participants (e.g., by awarding additional bids for referrals). The winner of the auction is the participant with the lowest unique bid. Revenues are generated through advertising. The system of this invention will be highly appealing to advertisers since participant profiles and bid patterns can be used to target advertising campaigns with high expected ROI's.

Prizes can range from hard-to-find luxury goods, cars, electronic appliances and autographed sports and celebrity goods, or more mundane items. The consumer appeal of the system is centered on the game aspect of the reverse auctions, the ability of participants to constantly check the status of their bids, and the ability to retract bids at will. A significant business to business appeal of the model is based on the ability to provide real-time reporting and profiling, and to target participants based on their demographics and bid patterns (e.g. time spent, product categories bid upon).

The bidding process is dynamic as participants would be able to retract bids and re-bid. Losing bids can become winning bids and winning bids can become losing bids on a second by second basis. Table 1 depicts bidding on an item at the start, after 1 and 2 hours, then at the finish. Table 2 depicts the feedback information provided to the participant at the start, after 1 and 2 hours, then at the finish. Participant A wins the auction after having losing bids throughout the bid process.

TABLE 1

| | Start | 1^{st} Hour | 2^{nd} Hour | Finish |
|---|---|---|---|---|
| Participant A | $1.25 | $1.25 | $1.25 | $1.25 |
| Participant B | $1.05 | [symbol] | | |
| | | $1.35 | $1.35 | $1.35 |
| | | | $1.00 | $1.00 |
| | | | | $1.10 |
| | | | | $1.15 |
| | | | | $1.17 |
| Participant C | $1.10 | $1.10 | $1.10 | $1.10 |
| | | | | $1.00 |
| | | | | $1.21 |
| Participant D | $1.05 | $1.05 | $1.05 | [symbol] |
| | | | $1.10 | $1.10 |
| | | | | $1.15 |
| | | | | $1.17 |
| | | | | $1.21 |
| | | | | $1.35 |

[symbol]

= Retracted Bids
$ = Duplicate Bids
Bolded = Lowest Unique Bids

TABLE 2

| | | | 2nd | |
|---|---|---|---|---|
| | Start | 1st Hour | Hour | Finish |
| Participant A Bid = | $1.25 | $1.25 | $1.25 | $1.25 |
| Total Bids | 4 | 4 | 6 | 14 |
| Total Bidders | 4 | 4 | 4 | 4 |
| Total Bids Higher | 0 | 1 | 1 | 2 |
| Total Bids Lower | 3 | 2 | 4 | 11 |
| Total Higher Unique Bids | 0 | 1 | 1 | 0 |
| Total Lower Unique Bids | 1 | 2 | 1 | 0 |
| Same as you | 0 | 0 | 0 | 0 |
| Status | Try | Try | Try | Won |
| | Again | Again | Again | |

In specific embodiments, based on the number of hours of usage of the site, participants are eligible for higher tiered membership that will contain special prizes and limit the number of bidders. Memberships create repeat participants and longer logged on times for the site, and combined with an “instant prizes” feature, will encourage participants to log in and stay logged on

The system can also have special associations with organizations that have high participant bases, such as telemarketing clubs, membership stores, and credit card clubs. Certain prizes can be obtained from such special clubs and offered only to their members, for example by providing such participants with promotional codes for access to special prizes. The limited number of club participants increases the chances of winning and provides incentives to the participants to join the club.

In addition, non-affiliated club memberships can be awarded, based, for example, on hours of play, such as in Table 3:

TABLE 3

| Hours per Month | Min. | Max. |
|---|---|---|
| Club Member | 100 | 200 |
| Platinum Member | 50 | 99 |
| Gold Member | 25 | 49 |
| Silver Member | 15 | 24 |
| Regular Member | 0 | 14 |

In a further embodiment, in order to maintain participant loyalty, a last “Dibber”¹ standing feature can be employed daily Participants that are signed up to an auction by a given time daily, are pitted against each other until only one participant (“dibber”) remains. This can be employed not only for auctions, but also for games and contests, such as bingo, rocks, paper, scissors, poker, trivia games, etc. ¹”Dibber” being a play on “bidder ” for a reverse auction”

Functional mobile applications can be built using SMS, WAP, and carrier portals. They can be free or require subscriptions, based on regulations and carrier negotiations. In the US, a revenue stream can be created by revenue sharing with carriers for data charges.

Prizes can be targeted to women, such as hard-to-find handbags, luxury and fashion goods, brand goods and diamonds. Prizes can be targeted to men, such as flat screen TVs, electronic goods, hard-to-find watches, tickets to sporting events and fashion goods. Or prizes can be targeted to both men and women, such as concert tickets, dinner vouchers, hotel vouchers, free travel to Hawaii and other destinations, and the like.

### Internet Embodiment

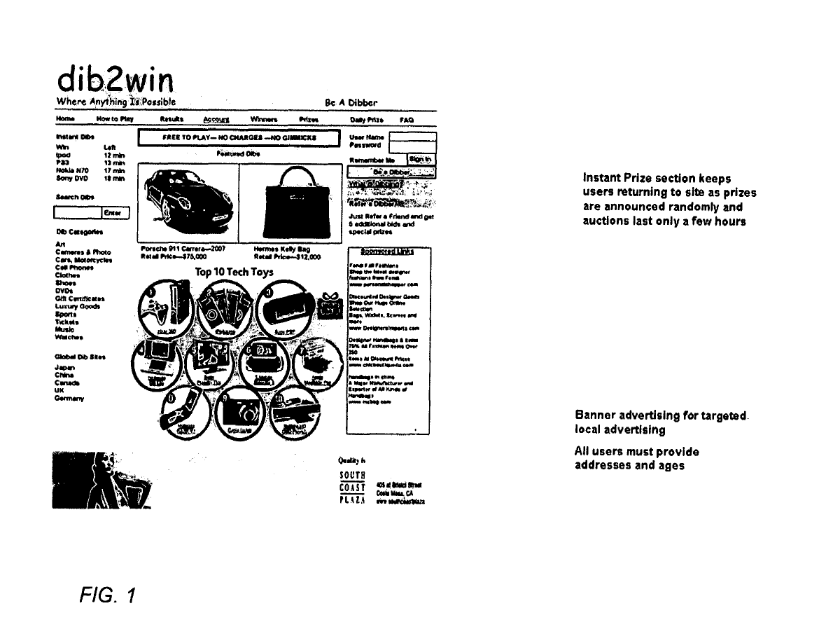

Referring to FIG. 1, a sample home page of an internet web site is shown illustrating aspects of the invention. The page has information about the game, in this case called “dib2win”², that includes the times left for various auctions, an “Instant Prize” section that are announced randomly from time to time, banner ads for targeted local advertising, sponsored links, and various items of information about the game, with links to information as to how to play the game, results, the participant's account, winners, prizes, the daily prize and a FAQ section. ²The phrase “dib2win” is a play on the words “bid to win” where “dib” is used instead of “bid” because it is a reverse auction.

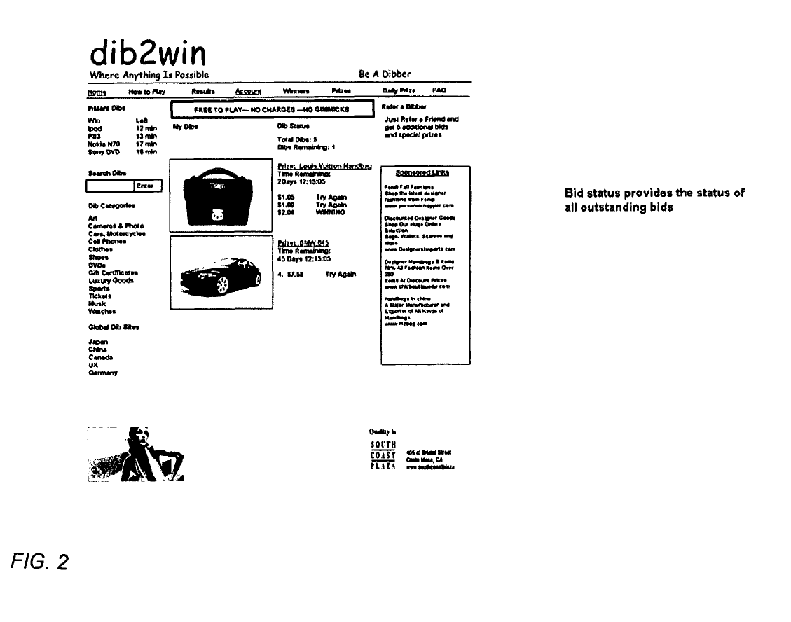

FIG. 2 is sample status page of the invention, having similar information and links as has the page of FIG. 1, but including dynamic information as to the bids of the participant accessing the page, and time remaining for the auctions that participant is bidding in. As shown by way of examples, this participant has 5 bids, has bid three times on a Louis Vutton Handbag, wherein one of those bids is so far winning, and has placed a single bid on a BMW 645. The screen also shows that only four bids (“Dibs”) out of a total allotment of five bids have been used, and gives the time remaining on for the auction on each of the two auctions.

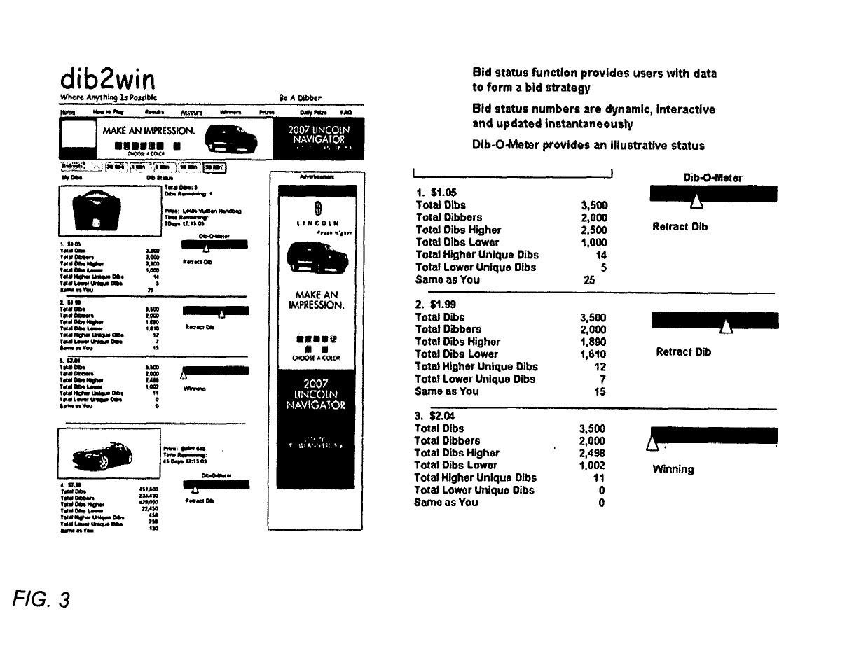

FIG. 3 is sample bid status page of the invention, called here a “dib-o-meter,” that is updated as to the bids of the participant accessing the page for one of the auctions being bid on. The bid status numbers are dynamic, interactive, and continuously updated, visually, with a moving line meter, and numerically. This provides the participant with data that can be used to form a bid strategy. Whereas the screen of FIG. 1 provided limited information about the participant's bids, the status page of FIG. 2, provides significant detail, including for each amount currently bid, the total bids, total number of bidders, total higher bids, total lower bids, total higher unique bids, total lower unique bids, and the number of bids that are the same as the participant.

### Cell phone, Mobile Site Embodiment

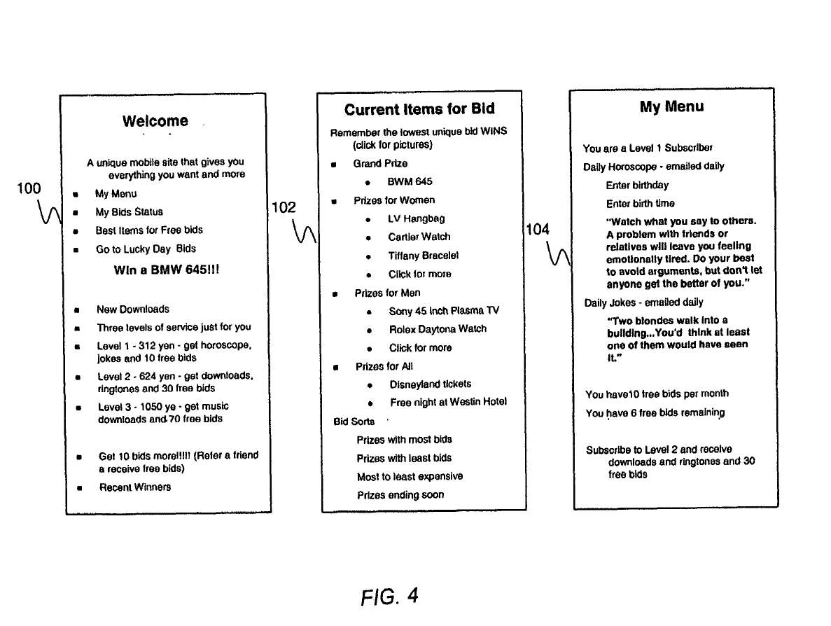

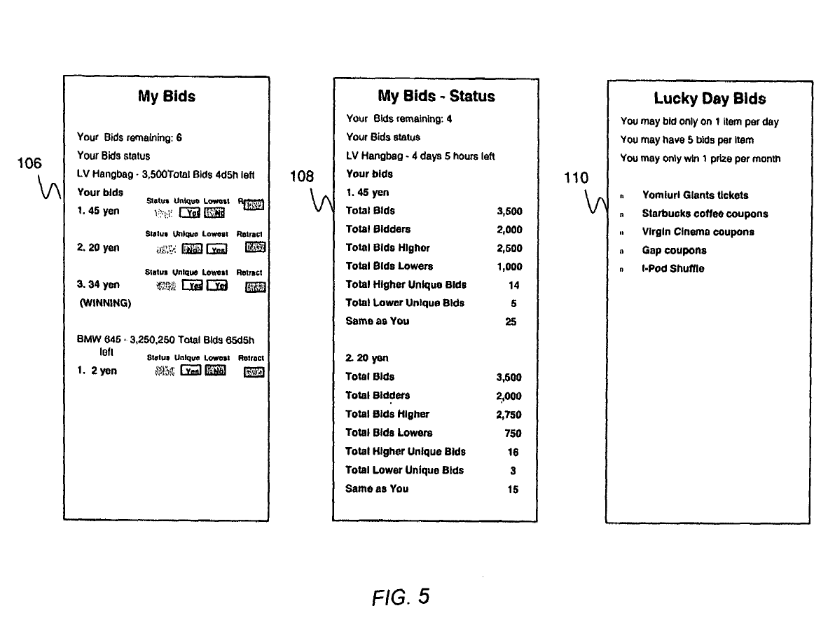

FIGS. 4 and 5 illustrate various mobile site pages that are cell phone accessible, provided by a free reverse auction server for display on a particular end device according to one embodiment of the invention. These mobile site pages are merely exemplary, and a person of skill in the art will recognize that other types of information and services may be accessible via mobile site pages without departing from the scope and spirit of the present invention.

Mobile page 100 allows a user access to various tools and/or services provided by the free reverse auction server, including accessing the status of his or her bids, information on current and future auctions, and links for subscribing to the services provided by the free reverse auction server. The server provides different service levels to which a user may subscribe. Each service level is associated with different subscription price, different types or levels of services or goods, and different number of free bids that the user may be allotted upon joining the particular service level.

Mobile page 102 provides more detailed information on current and future auction items and services associated with an on-going or future auction.

Mobile site page 104 is accessible to subscribed participants of the system, and provides to such subscribed participants general information and access to one or more services to which the participant has subscribed. For example, if the participant's subscription level includes daily horoscopes and jokes, such horoscopes and jokes are displayed on the mobile site page 104. The participant may also be given the option to upgrade to higher service levels to obtain extra goods/services and an increased number of free bids.

Mobile site page 106 provides information on the bids placed by the participant such as, for example, a number of free bids remaining and bid information for each reverse auction in which the participant is participating. Such bid information indicates the item/service that the participant had bid on, the total number of bids placed on the item/service, the time left before the auction is scheduled to end, the different bid amounts placed for the item/service by the participant, and an indication as to whether each bid amount is unique and lowest. The bid amount may be retracted by selecting a retract button. Additional information on the bid status may be obtained by selecting a status button.

Mobile page 108 provides more detailed bid status information for each bid amount placed by the participant. Such information includes, but is not limited to a total number of bids, total number of bidders, total number of bids higher than the current bid, total number of bids lower than the current bid, total number of unique bids higher than the current bid, total number of unique bids lower than the current bid, and total number of bids same as the current bid.

Mobile page 110 provides information on certain reverse auction items recommended to the participant for a particular day. Such items may be selected randomly or based on participant profile information manually entered by the participant or automatically learned about the participant over time based on monitored participant activity such as, for example, the participant's bidding habits.

General Considerations

In general terms, the present invention is directed to a system and method for providing a “free” reverse auction service for new or used goods and/or services over mobile and Internet networks where the bidders placing bids are not individuals charged for placing the bids. The winner of the auction is a bidder who submits the lowest unique bid at the end of a predetermined time period when the auction is scheduled to end. Although a provider of the free reverse auction service does not charge a fee each time a bid is placed, the provider may nonetheless generate a revenue in one or more of the following ways. For example, the free reverse auction service may be employed as an inducement to sell other valuable services and/or products. Only users paying for those services and/or products are given access to the free reverse auction service and are allowed to place the free bids. For example, mobile or Internet service providers may provide the free reverse auction service to differentiate themselves from their competitors. Providing the free reverse auction service to only subscribers may help attract new subscribers and retain existing subscribers. Subscribers are a source of revenue. In the mobile service scenario, subscribers purchase mobile phones and pay for voice and data services, generating revenue for the service provider.

The free reverse auction service may also be tied to a monthly or annual membership fee. The fee may be a fixed or variable amount. The membership may be for accessing the free reverse auction service, or for other goods and services independent of the free reverse auction service. Users paying the membership fee are allocated a limited number of free bids that may be used in one or more auctions. A bidder uses a free bid to place a wager amount is paid free bid to place a wager amount. The wager amount is paid only if the bidder wins the bid. The free reverse auction service may further be used in conjunction with an advertising model for generating revenue for the service provider. In this case, revenues flow from the advertisers who place ads with the reverse auction system.

According to one embodiment of the invention, the free reverse auction system provides for interactive bidding. This is unlike a traditional reverse auction system where the user's interaction ends with the initial placement of a bid. In such a traditional reverse auction system, the bidder waits blindly until the end of the auction to see if the bid was successful. The free reverse auction system according to the present embodiment allows a bidder to place bids, retract bids, and resubmit bids based on a constant feedback of the bidder 's current bid status, allowing the bidding process to be dynamic and interactive.

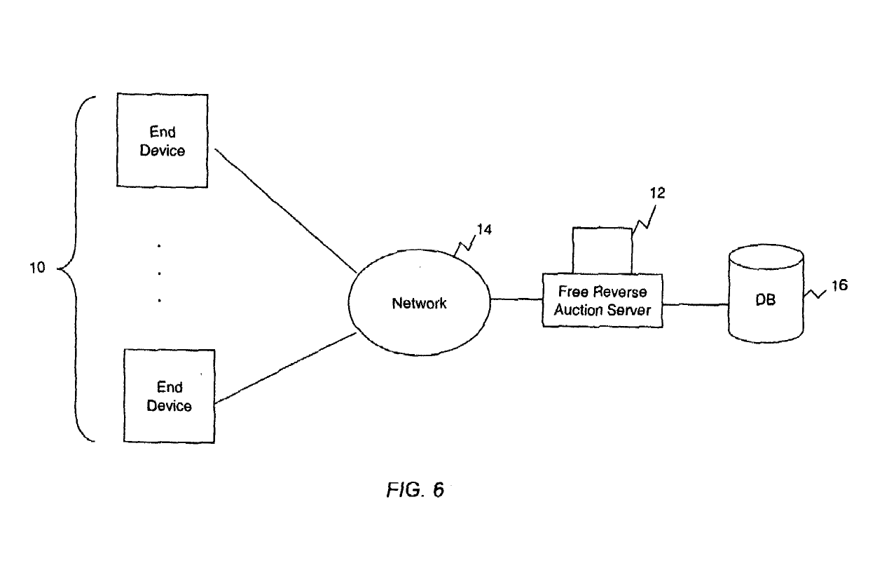

FIG. 6 is a block diagram of a free reverse auction system according to one embodiment of the invention. The system includes a free reverse auction server 12 coupled to a plurality of end user devices 10 over a wired or wireless data communications network 14. The server 12 is further coupled to a database 16 stored in a mass storage device. The mass storage device may take the form of a hard disk or disk array as is conventional in the art. The database 16 stores data associated with one or more reverse auctions, such, as for example, information on each bidder including his or her bid amount. The database 16 may further maintain for each bidder, the number of free bids allocated and remaining for each of the bidders.

The data communications network 14 may be a wireless network implemented using one or more of a wide variety of wireless solutions. For example, the wireless network may include, without limitation, a cellular telephone network such as a Global System for Mobile communications (GSM) or General Packet Radio Service (GPRS), a wireless local area network such as 802.11a, 802.11b, or 802.11g (collectively referred to as 802.11), or a personal area network such as Bluetooth. The data communications network 14 may also take the form a wired local area network, wired private wide area network, or the public Internet.

The end user device 10 may be a mobile phone, computer, laptop, personal digital assistant (PDA), or any other networked device with networking capabilities. According to one embodiment of the invention, the user device 10 is configured with the necessary software and hardware for accessing the free reverse auction server 12 and taking advantage of the services and/or goods it provides. Any software needed for such access may be downloaded over the data communications network, or may be preinstalled in the end user device prior to its sale.

According to one embodiment of the invention, the free reverse auction server 12 provides tools for allowing the user device 10 to participate in one or more reverse auctions. The free reserve auction server may also provide access to goods and/or services other than the free reverse auction service. One exemplary service is a horoscope service which provides horoscopes to the end user devices on a daily basis.

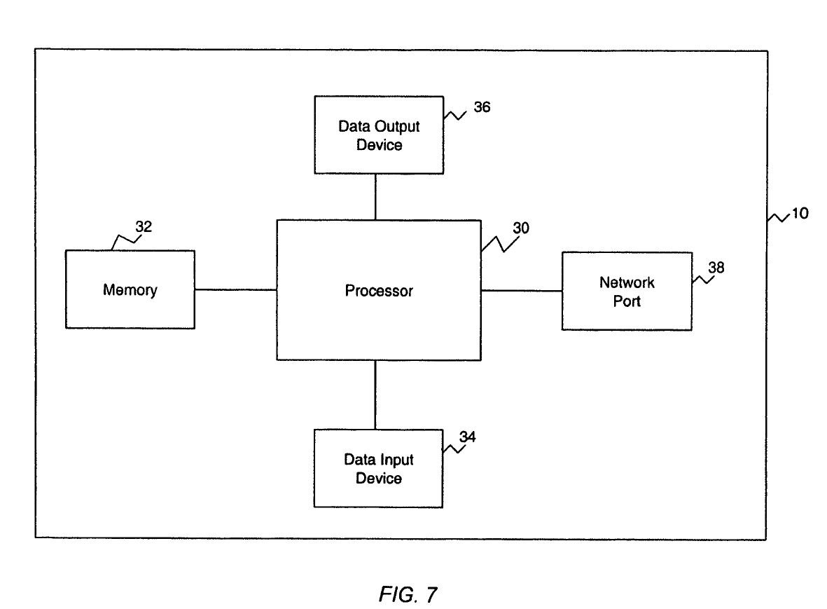

FIG. 7 is a block diagram of the end user device 10 according to one embodiment of the invention. The end user device 10 includes a processor 30, memory 32, data input device 34, data output device 36, and communications port 38.

The data input device 34 may take the form of a keyboard, keypad, control button, stylus, microphone, remote controller, and/or the like, for allowing a user to enter user input data. The user input data may be, for example, a user command place or retract a bid on a product or service being auctioned in a particular reverse auction. The user input data may also be a command to access an ancillary service provided by the free reverse auction server 12.

The data output device 36 may include a display screen for displaying text and/or graphics, speakers for outputting audio sounds, and/or the like. Pressure sensitive (touch screen) technology may also be incorporated into the display screen for allowing a user to provide additional data input by merely touching different portions of the display screen.

The communications port 38 allows the exchange of data between the end user device and one or more other computer devices in a wired or wireless manner. For example, the data communications port may be used to receive and/or transmit data from and/or to the free reverse auction server 12.

The memory 32 may include a read only memory, random access memory, flash memory, and the like. According to one embodiment, the memory stores computer program instructions which are executed by the processor 30 for accessing and participating in the free reverse auctions and other services provided by the free reverse auction server.

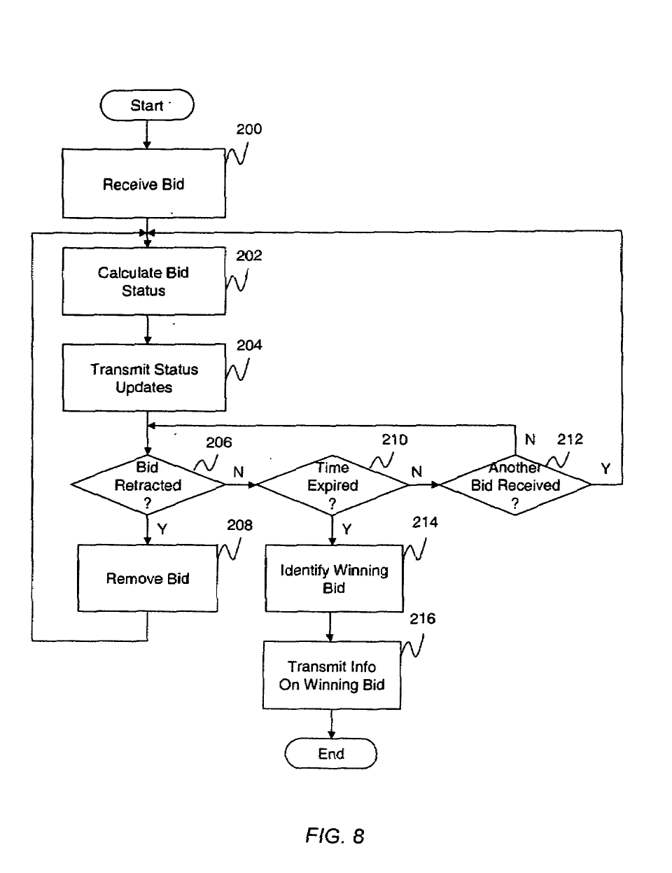

FIG. 8 is a process flow diagram of a process engaged by the free reverse auction server for receiving and updating bid status information according to one embodiment of the invention. The process may be implemented via a bid processing module hosted by the free reverse auction server. The bid processing module may be a software module which is executed by a processor hosted by the server based on computer program instructions stored in the server's memory. A person of skill in the art should recognize, however, that the process may be implemented via hardware, firmware, or any combination of hardware, firmware, and/or software.

A new bidder participates in a particular reverse auction by using the end user device to access a mobile site page for the particular reverse auction and entering a bid amount. The bid amount is transmitted over the data communications network 14 to the free reverse auction server 12. The bid processing module in the server 12 receives the bid in step 200, and in step 202, calculates a bid status for the new bidder as well as other subscribed bidders who have a bid outstanding for the particular reverse auction. In this regard, the bid processing module retrieves information in the database 16 for the reverse auction for which the bid was received, and increases the total bids and bidders information by one. The bid processing module then compares the current bid amount with other bid amounts that are outstanding for the auction, and determines the number of bids that are higher, lower, and same as the current bid. The bid processing module further determines the number of unique higher and unique lower bid amounts. This information is then transmitted to the new bidder in step 204.

The bid processing module also determines the bid status of other bidders based on the newly received bid, and transmits to each such bidder updated information on the total bids and bidders in step 204. The bid processing module further calculates for each such other bidder the number of bids that are higher, lower, and same as the bid currently outstanding for the bidder. The bid processing module also determines the number of unique higher and unique lower bid amounts for the bidder. The updated status information is then transmitted to each of the other bidders in step 204.

In step 206, a determination is made as to whether the new bidder has retracted his or her bid. If the answer is YES, the bid is removed in step 208, and the bid status information is updated for the new bidder as well as the other bidders. The updated information is then transmitted to each of the bidders.

In step 210, a determination is made as to whether the time allotted to the particular reverse auction has expired. If the answer is NO, a determination is made in step 212 as to whether another bid has been received. If another bid was received, the process returns to step 202 to update the bid status information for each of the bidders.

If the reverse auction time has expired, the bid processing module identifies the winning bid in step 214. According to one embodiment of the invention, the lowest unique bid is selected as the winning bid. In step 216, information on the winning bid is transmitted to each participating bidder.

It will be appreciated that the ability of bidders to view their current bids in relation to other bids gives the bidders the opportunity to calculate the odds of winning. Because bidding is interactive, a bidder may make more educated bids based on such calculations, and retract an old bid and submit a new bid, or submit multiple bids of different amounts.

Although the present invention has been described in connection with the preferred embodiments, it is to be understood that modifications and variations may be utilized without departing from the principles and scope of the invention, as those skilled in the art will readily understand. Accordingly, such modifications may be practiced within the scope of the following claims.

1. In a method for conducting a reverse auction in which bids for one or more articles of merchandise or one or more services are made by bidders, the winner of the auction being the bidder with the lowest unique bid at the end of the auction, the improvement according to which:
(a) each bidder is allowed a predetermined number of bids;
(b) during the course of the auction, each bidder is provided with information about the bidding for the auction comprising one or more of:
(1) the total number of bids,
(2) the total number of bidders,
(3) the total number of higher bids,
(4) the total number of lower bids,
(5) the total number of higher unique bids,
(6) the total number of lower unique bids, or
(7) the total number of bids same as this bid;
and
(c) each bidder may retract one or more of his or her bids and make one or more bids in place of the one or more retracted bids.

2. The method of claim 1 in which no charge is made to the bidders for participating in the reverse auction.

3. The method of claim 1 in which the bidder may retract the one or more bids at any time before the end of the auction,

4. The method of claim 1 in the end of the auction occurs at the end of a predetermined period of time or when a predetermined number of bids have been placed.

5. The method of claim 1 in which the predetermined number of bids can be used in single auction or divided between two or more auctions.

6. The method of claim 1 in which the information provided to each bidder comprises:
(1) the total number of bids,
(2) the total number of bidders,
(3) the total number of higher bids,
(4) the total number of lower bids,
(5) the total number of higher unique bids,
(6) the total number of lower unique bids, and
(7) the total number of bids same as this bid.

7. The method of claim 1 in which the reverse auction is conducted on an internet web site.

8. The method of claim 1 in which the reverse auction is conducted on a mobile system accessible by cell phones.

9. The method of claim 1 in which the reverse auction is conducted on both an internet web site and on a mobile system accessible by cell phones.

10. The method of claim 1 in which bids are distributed to bidders in accordance with the bidders' membership in specific organizations.

11. The method of claim 1 in which items of merchandise or services to be auctioned are made available to bidders in accordance with the bidders's membership in specific organizations.

12. The method of claim 1 implemented on a computer.

13. In a computer implemented method for conducting a free reverse auction, an internet web site, or on a mobile system accessible by cell phones, in which bids for one or more articles of merchandise or one or more services are made by bidders, without charge for the bids, the winner of the auction being the bidder with the lowest unique bid at the end of a predetermined period of time or when a predetermined number of bids have been placed, the improvement according to which:
(a) each bidder is allowed a predetermined number of bids that can be used in single auction or divided between two or more auctions;
(b) during the course of the auction, each bidder is provided with information about the bidding for the auction comprising:
(1) the total number of bids,
(2) the total number of bidders,
(3) the total number of higher bids,
(4) the total number of lower bids,
(5) the total number of higher unique bids,
(6) the total number of lower unique bids, and
(7) the total number of bids same as this bid;
and
(c) each bidder may retract one or more of his or her bids and make one or more bids in place of the one or more retracted bids, at any time before the end of the auction.
